(19) United States
(12) Patent Application Publication
(10) Pub. No.: US 2024/0429757 A1
(43) Pub. Date: Dec. 26, 2024

(54) MODEL VEHICLE ELECTRONIC BRUSHLESS MOTOR SYSTEM

(71) Applicant: TRAXXAS, L.P., McKinney, TX (US)

(72) Inventors: Adam Cole Ewing, McKinney, TX (US); Wesley R. Erhart, McKinney, TX (US); Randy Perez, McKinney, TX (US); Mark Mains, Plano, TX (US)

(73) Assignee: TRAXXAS, L.P., McKinney, TX (US)

(21) Appl. No.: 18/750,100

(22) Filed: Jun. 21, 2024

Related U.S. Application Data
(60) Provisional application No. 63/522,467, filed on Jun. 22, 2023.

(51) Int. Cl. H02K 1/16; H02K 1/27; H02K 3/04; H02K 19/02

(52) U.S. Cl. CPC H02K 1/16; H02K 1/27; H02K 3/04; H02K 19/02

(57) ABSTRACT

An Remote Controlled (RC) electronic brushless motor system is provided. The electronic brushless motor system is a brushless direct current (BLDC) motor system including a transmitter and RC model vehicle. The BLDC motor includes a stator containing a number of stacked slotted steel laminate plates in which Low Cost (LC) magnets are pressed into corresponding slots. The LC magnets are configured in a salient manner. The rotor is provided including a number of stacked steel laminate plates configured in as a six-slot motor in one embodiment. The rotor is wound with copper wire in a delta configuration.

### RELATED APPLICATIONS

This application claims the benefit of a related U.S. Provisional Application Ser. No. 63/522,467, filed Jun. 22, 2023, entitled “MODEL VEHICLE ELECTRONIC BRUSHLESS MOTOR SYSTEM,” to Adam Cole Ewing et al., the disclosure of which is incorporated by reference herein in its entirety.

### BACKGROUND

The following descriptions and examples are not admitted to be prior art by virtue of their inclusion in this section.

Radio-Controlled or RC model vehicles are a popular hobby for a growing segment of the population. In the case of electrically powered vehicles, as the electronics become more sophisticated and the batteries more advanced, the ease of operation and the run time of RC model vehicles have increased dramatically. In addition, ever more powerful brushless electric motors have enabled higher and higher speeds of RC model vehicles. However, these brushless motors use high end components and assembly methods that increase the overall cost of an average RC model vehicle.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In accordance with one embodiment, a remote-control (RC) model vehicle using a Low Cost (LC) Brushless Direct Current (BLDC) motor is provided. The LC BLDC motor including an LC salient rotor having two or more LC magnets and a plurality of silicon steel laminated LC central plates. The LC central plates including a plurality of slots configured and corresponding to the two or more LC magnets. Wherein each LC magnet of the two or more LC magnets are inserted into a corresponding slot of the plurality of slots. In addition, the LC BLDC motor includes an LC stator, wherein the LC stator is a delta connection wire wound LC stator.

In accordance with another embodiment, a remote-control (RC) system comprising a transmitter and an RC model vehicle is provided. The RC model vehicle including a Low Cost (LC) Brushless Direct Current (BLDC) motor. The LC BLDC motor having an LC salient rotor having two or more LC magnets and a plurality of silicon steel laminated LC central plates. The LC central plates further including a plurality of slots configured and corresponding to the two or more LC magnets, wherein each LC magnet of the two or more LC magnets are pressed into a corresponding slot of the plurality of slots.

In addition, the LC BLDC motor includes an LC stator, wherein the LC stator is a delta connection wire wound LC stator. Also, wherein the transmitter wirelessly communicates with the RC model vehicle to control the LC BLDC motor.

Other or alternative features will become apparent from the following description, from the drawings, and from the claims.

### BRIEF DESCRIPTION OF THE DRAWINGS

Certain embodiments will hereafter be described with reference to the accompanying drawings, wherein like reference numerals denote like elements. It should be understood, however, that the accompanying drawings illustrate only the various implementations described herein and are not meant to limit the scope of various technologies described herein. The drawings are as follows:

FIG. 1 is a schematic layout of a prior art RC model vehicle system;

FIG. 2 is a cross-sectional view of a prior art brushless, direct current, non-salient electronic motor shown in FIG. 1;

FIG. 3 is a schematic layout of an RC model vehicle system, according to an embodiment of this disclosure; and

FIG. 4 is a cross-sectional view of a brushless, direct current, salient electronic motor shown in FIG. 3, according to an embodiment of this disclosure.

### DETAILED DESCRIPTION

In the following specification, numerous specific details are set forth to provide a thorough understanding of embodiments of the present disclosure. However, those skilled in the art will appreciate that the embodiments may be practiced without such specific details. In other instances, well-known elements have been illustrated in schematic or block diagram form in order not to obscure embodiments of the present disclosure in unnecessary detail.

Reference throughout the specification to “one embodiment,” “an embodiment,” “some embodiments,” “one aspect,” “an aspect,” or “some aspects” means that a particular feature, structure, method, or characteristic described in connection with the embodiment or aspect is included in at least one embodiment of the present disclosure. Thus, the appearance of the phrases “in one embodiment” or “in an embodiment” or “in some embodiments” in various places throughout the specification are not necessarily all referring to the same embodiment. Furthermore, the particular features, structures, methods, or characteristics may be combined in any suitable manner in one or more embodiments. The words “including” and “having” shall have the same meaning as the word “comprising.”

Moreover, inventive aspects lie in less than all features of a single disclosed embodiment. Thus, the claims following the Detailed Description are hereby expressly incorporated into this Detailed Description, with each claim standing on its own as a separate embodiment.

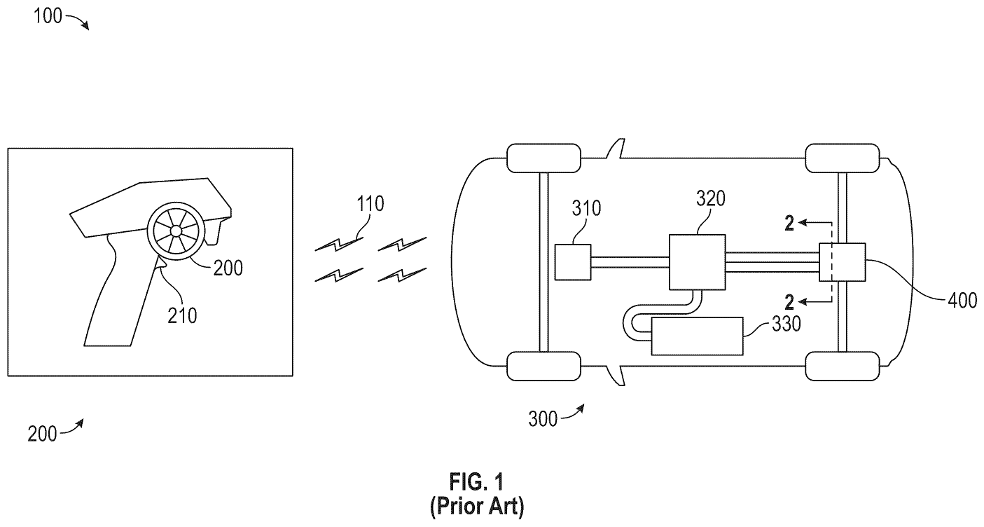

As shown in FIG. 1, a typical Radio Controlled (RC) model vehicle system 100 includes an operator held transmitter 200 and an RC model vehicle 300. The transmitter 200 is controlled by an operator remotely positioned away from the RC model vehicle 300. A transmitter 200 basically includes a throttle input 210 that commands forward, reverse, and braking instructions for the RC model vehicle 300. In addition, a transmitter 200 may include a steering input 220 in the shape of a steering wheel or even using a stylized vehicle wheel for example. Further, the transmitter 200 may include additional buttons, switches, knobs, and joysticks for inputs other than the throttle input 210 and the steering input 220.

Once the transmitter 200 is linked to the RC model vehicle 300, the operator may control the throttle input 210 and steering input 220, among any other appropriate inputs provided on the transmitter 200, and the signals produced by the various inputs will be wirelessly communicated 110 between the transmitter 200 and the RC model vehicle 300. The RC model vehicle 300 may further comprise a receiver (e.g., vehicle controller) 310, an electronic speed controller (ESC) and battery eliminator circuit (BEC) 320, a battery (i.e., NiMH, LiPo, energy storage device) 330 and an electric motor 400.

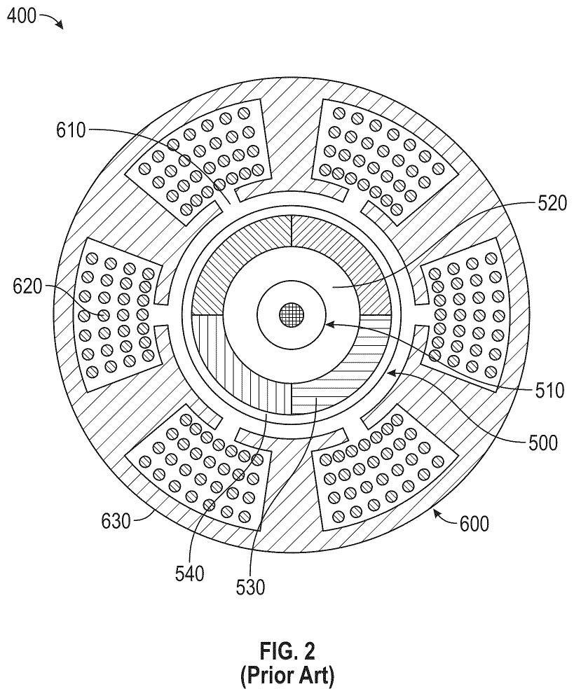

The wireless communications 110 between the transmitter 200 and the RC model vehicle 300 may be received and interpreted by the receiver 310. The processed instructions may then be transmitted to the ESC/BEC 330, which would then determine how much, if any, power to provide to the motor 400. In some cases, the motor 400 may be a brushless, direct current (BLDC), non-salient motor, provided with a wye wound stator 600 (see FIG. 2) and a permanent magnet 530 rotor 500 (see FIG. 2).

Referring generally to FIG. 2, this figure contains a schematic overview of the motor 400 in FIG. 1, cut along the 2, 2, lines (as shown in the figure). The motor 400 may comprise a rotor 500 and a stator 600. The rotor 500 may further include a centrally located axle 510 surrounded by silicon coated steel laminate central plates 520. The steel laminate central plates 520 may be surrounded by shaped, non-saliently provided magnets 530 (4 permanent magnets are shown in this illustrative example). The magnets 530 may then be surrounded by an external rotor casing 540 (i.e., Kevlar for example).

The stator 600 may comprise silicon coated steel laminated external plates 630 configured as a 6-slot electric motor (6 is only an illustrative example, other number of slots familiar to those of skill in the art, such as 9 or 12, among others, may be used). These external plates 630 may be similar to the internal plates 520, and all of the plurality of internal and external plates may respectively be stacked upon each other to form the stator 600 and rotor 500.

Conductive wire 620 (such as copper) may be wound around the respective slots in a Wye configuration. The magnets 530 are shaped to form a continuous ring around the center plates 520. Creating the magnets 530 in this manner is done via a relatively expensive manufacturing process. However, since BLDC motors 400 are considered as a relatively high-end configuration of the RC motor market, the cost has typically been justified and passed along to the consumer.

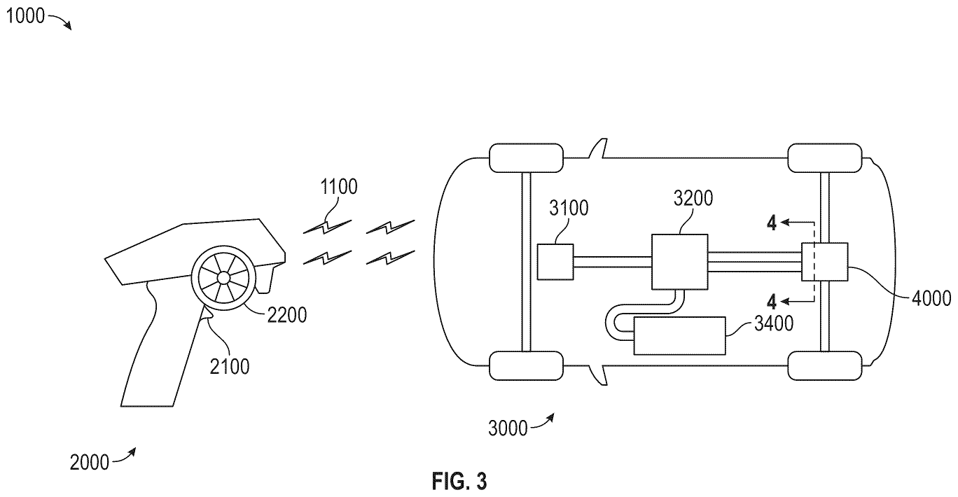

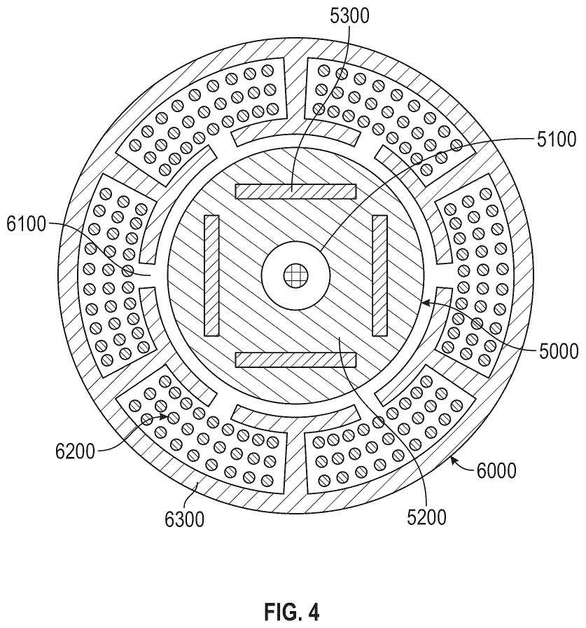

In the embodiments shown in FIGS. 3 and 4, applicants have attempted to lower the overall cost of an RC model vehicle by using a lower-cost configuration of an BLDC motor, something they have not seen in the prior art.

Referring generally now to FIG. 3, a system using a lower cost configuration of BLDC motor is shown in an exemplary embodiment of the current disclosure. In this embodiment, an RC Low Cost (LC) System 1000 comprises a low cost (LC) transmitter 1000 and an RC low cost (LC) model vehicle 3000. LC will be used hereafter to differentiate these components from the prior art. Although, in many cases, similar components may be used in each type of system.

The LC transmitter 2000 may comprise an LC throttle input 2100 and an LC steering input 2200. The LC transmitter 2000 may be substantially the same as the transmitter 200 in the prior art. The LC throttle input 2100 commands forward, reverse, and braking instructions for the RC LC model vehicle 3000. The LC throttle input 2100 may be a trigger actuated by an operator's finger or a joystick, for example.

The LC steering input 2200 commands left and right turns for the RC LC model vehicle 3000 via a servo driven steering mechanism. The LC steering input 2200 may be in the shape of a steering wheel or a stylized model vehicle wheel for example. However, embodiments of the LC steering wheel 2200 are not limited to these configurations and may include other forms of generating a steering command, such as a joystick, as pointed out for the LC throttle input 2100 as well. Further, the LC transmitter 2000 may include additional buttons, switches, knobs, and joysticks for other input such as lights, vehicle sounds, and turn signals, among others.

The signals generated by the LC throttle input 2100 and LC steering input 2200 may be transmitted between the LC transmitter 2000 and the RC LC model vehicle 3000 via a substantially similar LC wireless communications 1100. The signals sent by the LC transmitter 2000 may be received by the RC LC model vehicle 3000's LC receiver 3100 (e.g. LC vehicle controller). The RC LC model vehicle may also comprise an LC electronic speed controller (ESC) and battery eliminator circuit (BEC) 3200, an LC battery 3400, and an LC motor 4000.

The LC battery 3400 may use a Nickel Metal Hydride (NiMH) or Lithium Polymer (LiPo) chemical composition, for example. However, battery technology is advancing quickly and other battery compositions such as solid-state batteries or other forms of energy storage may also be used.

The LC wireless communications 1100 between the LC transmitter 2000 and the RC LC model vehicle 3000 may be received and interpreted by the LC receiver 3100. The processed instructions may then be processed by the LC ESC/BEC 3300, which would then determine how much, if any, power to provide to the LC motor 4000. In this exemplary embodiment, the LC motor 4000 may be a brushless, direct current (BLDC), salient motor, provided with a delta wound LC stator 6000 (see FIG. 4) and an LC magnet 5300 configured LC rotor 5000 (see FIG. 4).

Referring generally to FIG. 4, this figure contains a schematic overview of an embodiment of the LC motor 4000 shown in FIG. 3, cut along the 4, 4, lines (as shown in the figure). The LC motor 4000 may comprise an LC rotor 5000 and an LC stator 6000. The LC rotor 5000 may further include a centrally located LC axle 5100 surrounded by silicon coated steel laminate LC central plates 5200.

Provided within the steel laminate LC central plates 5200 are two or more rectangularly shaped LC magnets 5300, that are rectangularly shaped permanent magnets in this exemplary example. The LC magnets 5300 may be evenly spaced about the circumference of the LC rotor 5000, effectively forming a non-salient LC rotor 5000. In some embodiments, the LC magnets 5300 may be pressed into place within the assembled stack of steel laminate LC central plates 5200. While this embodiment uses rectangularly shaped permanent magnets for the LC magnets 5300, other configurations and geometries may be used as appropriate.

Instead of the continuous coverage about the circumference of the rotor 500 as shown in FIG. 3, the use of rectangularly shaped LC magnets 5300, results in spaces between the corners of all the LC magnets 5300. In addition, four LC magnets 5300 are shown in FIG. 4, however, other numbers of LC magnets 5300 may be used as appropriate.

The LC stator 6000 may comprise silicon coated steel laminated LC external plates 6300 configured as a 6-slot electric motor (6 is only an illustrative example, other numbers of slots familiar to those of skill in the art, such as 9 or 12, among others, may be used). These LC external plates 6300 may be structurally similar to the LC internal plates 5200, and the plurality of LC internal and LC external plates may be respectively stacked upon each other to form the LC stator 6000 and LC rotor 5000.

Conductive wire 6200 (such as copper) may be wound around the respective slots in a delta configuration. After respective manufacturing of the LC stator 6000 and the LC rotor 5000, the LC motor 4000 may be assembled and wired to the LC ESC/BEC 3200. The LC ESC/BEC is programmed to take a throttle input from the LC transmitter 2000 and supply a corresponding amount of electricity from the LC battery 3300.

Accordingly, a relatively lower priced RC LC model vehicle 3000 may be created as compared to RC model vehicle 300 containing a salient, wye-wound motor 400.

Although only a few example embodiments have been described in detail above, those skilled in the art will readily appreciate that a wide range of variations, modifications, changes, and substitutions are contemplated in the foregoing disclosure and, in some instances, some features of the present disclosure may be employed without a corresponding use of the other features.

It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A remote-control (RC) model vehicle using a Low Cost (LC) Brushless Direct Current (BLDC) motor, comprising:
an LC salient rotor comprising:
two or more LC magnets;
a plurality of silicon steel laminated LC central plates comprising;
a plurality of slots configured and corresponding to the two or more LC magnets;
wherein each LC magnet of the two or more LC magnets are pressed into a corresponding slot of the plurality of slots;
an LC stator; and
wherein the LC stator is a delta connection wire wound LC stator.

2. The RC model vehicle as claimed in claim 1, wherein the LC magnets are rectangularly shaped bar magnets.

3. The RC model vehicle as claimed in claim 1, wherein the LC stator is a six-slot stator.

4. The RC model vehicle as claimed in claim 1, wherein the two or more LC magnets are four LC magnets.

5. The RC model vehicle as claimed in claim 1, wherein the LC stator wire is copper wire.

6. The RC model vehicle as claimed in claim 1, wherein the LC magnets are permanent magnets.

7. The RC model vehicle as claimed in claim 1, wherein the LC magnets are inserted by pressing into the plurality of LC central plates.

8. The RC model vehicle as claimed in claim 1, wherein the LC stator is a twelve-slot stator.

9. A remote-control (RC) system comprising a transmitter and an RC model vehicle, comprising:
the RC model vehicle further comprising a Low Cost (LC) Brushless Direct Current (BLDC) motor comprising;
an LC salient rotor comprising:
two or more LC magnets;
a plurality of silicon steel laminated LC central plates comprising;
a plurality of slots configured and corresponding to the two or more LC magnets;
wherein each LC magnet of the two or more LC magnets are pressed into a corresponding slot of the plurality of slots;
an LC stator;
wherein the LC stator is a delta connection wire wound LC stator; and
wherein the transmitter wirelessly communicates with the RC model vehicle to control the LC BLDC motor.

10. The RC system as claimed in claim 9, wherein the LC magnets are rectangularly shaped bar magnets.

11. The RC system as claimed in claim 9, wherein the LC magnets are permanent magnets.

12. The RC system as claimed in claim 9, wherein the two or more LC magnets are four LC magnets.

13. The RC system as claimed in claim 9, wherein the LC stator is a six-slot stator.

14. The RC system as claimed in claim 9, wherein the LC stator wire is copper wire.
